(19) United States
(12) Patent Application Publication
(10) Pub. No.: US 2006/0265952 A1
(43) Pub. Date: Nov. 30, 2006

(54) Biodegradable consumable article with embedded seeds

(76) Inventor: Dean Vegas Christal, Santa Barbara, CA (US)

Correspondence Address: BARBER LEGAL, P.O. BOX 16220, GOLDEN, CO, 80402-6004, US

(21) Appl. No.: 11/139,360

(22) Filed: May 29, 2005

(51) Int. Cl. A01G 9/02

(52) U.S. Cl. 47/65.7

(57) ABSTRACT

A container for consumables such as cosmetics, hair and skin care products, foods, small appliances, optical disks and other consumables may be made of a biodegradable material having incorporated therein seeds of plants suitable for germination. The seeds may be selected for hardiness, attractiveness of the seed, plant or name, climate, likelihood of germination and other attributes. The seeds may be incorporated in a secondary space in the container, or embedded in the material of the container either wholly or partially, or in one or more layers of a multi-layer container. The container material may be natural or artificial plastic, cardboard, paper, fabric, or any other biodegradable material. The container may incorporate fertilizer, germination agents, agents to speed breakdown of the container. Different varieties of seeds may be used in the container, and for pleasing aesthetic effect, the seeds may be visible thru partially or wholly transparent material.

### FIELD OF THE INVENTION

This invention relates generally to containers and other consumable articles and specifically to biodegradable consumer articles.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

The problem of landfill use, overuse and location is greatly exacerbated by the great volume and unsightly nature of the materials placed into landfills. One result is the popularization of the use of biodegradable materials. These materials degrade away at a relatively fast pace, thus reducing the bulk in the landfill. However, they do relatively little to improve the overall appearance of the landfill, which tends to resemble a low rolling range of hills made entirely of garbage, entirely denuded of any flora except for the occasional weed.

The largest single component of most landfills falls into the general rubric of “consumable articles”, that is articles, especially containers, which have a primary interior space dimensioned and configured to hold a consumable good. When the good (for example, hair care product) is consumed, the empty container is thrown away.

Obviously, there is an un-met demand among people of faith and individuals of high environmental interest for products which help improve landfills in esthetic and ecological terms. It would be advantageous to provide structures which automatically biodegrade in a landfill, yet which also automatically seed the landfill.

One item of interest is the well known “Chia Pet” for sale at numerous retail outlets. This ceramic figurine has a species of plant growing in a large number small pock marks on the surface. The figurine itself largely lacks any ability to be used as a consumable product container, and while the low-fired ceramic of which it is constructed presumably erodes away, it is not “biodegradable” as the word is normally used. Since it is not a consumable goods container, it lacks relevance to the present invention.

U.S. Pat. No. 236,637 issued Jan. 2, 1945 to G. B. Zois, teaches a floral arrangement in which flowers may be arranged on a framework in order to form a funerary display. It lacks biodegradable materials, seeds, and structures for sales of consumable goods and thus fails to hold significant relevance to the present invention.

U.S. Pat. No. 4,027,606 issued Jun. 7, 1977 to Knapp teaches an agricultural implement for planting small disks of pulverulent material containing seeds. It lacks any structures for sales of consumer goods, and since it is not a consumable goods container, it simply lacks meaningful relevance to the present invention.

U.S. Pat. No. 4,118,889 issued Oct. 10, 1978 to Lamlee teaches a seedling container for sprouting a seed: the container may be worn as an accessory or as jewelry. However, it contains no primary space for use with a consumable product such as a cosmetic, or skin care product, or food, and it is also not biodegradable. Since it is not a consumable goods container, it too teaches little of relevance to the present invention.

U.S. Pat. No. 4,224,882 issued Sep. 30, 1980 to Cruse teaches an agricultural implement which allows a farmer to easily plant into the earth seeds contained in a liquid suspension. It is not a container or other consumable article, lacks biodegradable materials and of course since it is not a consumable goods container, it further lacks significant relevance to the present invention.

U.S. Pat. No. 4,434,231 issued Feb. 28, 1984 to Jung teaches an agent which promotes the growth of plants, and the agent itself comprises microorganisms embedded within a polymer matrix. However, the reference lacks seeds, biodegradable structures for sales of consumer products and since it is not a container for consumable goods, it too lacks close relevance to the present invention.

U.S. Pat. No. 4,891,905 issued Jan. 9, 1990 to Stolz teaches a polymer plant receptacle lacking consumable product spaces and seeds, and since it is not a consumable goods container, it is yet another reference which lacks significant relevance to the present invention.

U.S. Pat. No. 5,444,113 issued Aug. 22, 1995 to Sinclair et al teaches a polymer composition which allows biodegradability. However, since the products made therewith may lack seeds and may lack internal consumer product spaces its only significant relevance is the teaching of a biodegradable polymer, of which various types are already known in the art.

U.S. Pat. No. 5,549,500 issued Aug. 27, 1996 to Manoah teaches a figurine having an agent to promote plant growth (a nutrient material) and teaches numerous small holes through which the sprouts of seeds may grow. Unfortunately, since it is not a consumable goods container, it further has little relevance to the present invention.

U.S. Pat. No. 5,961,906 issued Oct. 5, 1999 to Muller et al is another reference which teaches a biodegradable material but does not teach that it may be used to make a consumer container, nor that such consumer container may then have embedded therein seeds. Since it is not a consumable goods container, it again lacks very much relevance to the present invention other than the introduction of a biodegradable material.

US Patent Publication No. 2004/0111964 issued Jun. 17, 2004 to Skuba teaches a fabric impregnated with seeds. However, as will be clear, it does not teach a container for consumable goods and thus it largely lacks relevance to the present invention.

### SUMMARY OF THE INVENTION

General Summary

A container for consumables such as cosmetics, hair and skin care products, foods, small appliances, optical disks and other consumables may be made of a biodegradable material having incorporated therein seeds of plants suitable for germination. The seeds may be selected for hardiness, attractiveness of the seed, plant or name, climate, likelihood of germination and other attributes. The seeds may be incorporated in a secondary space in the container, or embedded in the material of the container either wholly or partially, or in one or more layers of a multi-layer container. The container material may be natural or artificial plastic, cardboard, paper, fabric, or any other biodegradable material. The container may incorporate fertilizer, germination agents, agents to speed breakdown of the container. Different varieties of seeds may be used in the container, and for pleasing aesthetic effect, the seeds may be visible thru partially or wholly transparent material.

Summary in Reference to Claims

It is therefore a first aspect, advantage, objective and embodiment of the invention to provide a consumable container comprising:
a body made of a material;
a first space within the body dimensioned and configured so as to accommodate a consumable product; and
at least one seed at least partially within the container, and at a location within the container other than the first space.

It is therefore a second aspect, advantage, objective and embodiment of the invention to provide a consumable container further comprising:
a second space, and further wherein:
the seed is located in the second space.

It is therefore another aspect, advantage, objective and embodiment of the invention to provide a consumable container wherein the body material further comprises:
a biodegradable material, and further wherein:
the seed is at least partially embedded in the biodegradable material.

It is therefore another aspect, advantage, objective and embodiment of the invention to provide a consumable container further comprising:
a cover of a biodegradable material; and further wherein:
the seed is at least partially embedded in the biodegradable material of the cover.

It is therefore yet another aspect, advantage, objective and embodiment of the invention to provide a consumable container further comprising:
a sub-container within the container, the sub-container having a seed space therein, wherein:
the seed is located in the seed space.

It is therefore yet another aspect, advantage, objective and embodiment of the invention to provide a consumable container further comprising:
a sub-container on the exterior of the container and part thereof wherein:
the seed is located in the sub-container.

It is therefore yet another aspect, advantage, objective and embodiment of the invention to provide a consumable container wherein the biodegradable material further comprises one member selected from the group consisting of: natural polymers, artificial polymers, paper, fiber, cardboard, fabric, foams, composites thereof and combinations thereof.

It is therefore yet another aspect, advantage, objective and embodiment of the invention to provide a consumable container wherein the body further comprises one member selected from the group consisting of:
a bottle, a bag, a box, a food container, a cosmetic container, and an optical disk container.

It is therefore yet another aspect, advantage, objective and embodiment of the invention to provide a consumable container wherein the seed is selected from the group consisting of: seeds of wildflowers, seeds of grasses, cuttings, spores, achenes, bioengineered seeds, chitted seeds with dormancy broken, seeds of plants selected for high germination rates, seeds of plants selected for name appeal, seeds of plants selected for appealing appearance of the seed, seeds of plants selected for appealing appearance of the plant, seeds selected for ability to germinate within the matrix of the biodegradable material, seeds selected based upon climates in which the consumable container may be expected to be emptied and disposed of, seeds selected for ability to withstand manufacture of the container, and combinations thereof.

It is therefore yet another aspect, advantage, objective and embodiment of the invention to provide a consumable container further comprising:
indicia urging disposal of the consumable container in a biodegradable garbage container.

It is therefore yet another aspect, advantage, objective and embodiment of the invention to provide a consumable container wherein the seed is entirely embedded within the material of the body of the container.

It is therefore yet another aspect, advantage, objective and embodiment of the invention to provide a consumable container wherein the seed is at least partially exposed from the material of the body of the container.

It is therefore yet another aspect, advantage, objective and embodiment of the invention to provide a consumable container wherein the body of the container further comprises:
at least a first layer having the seed at least partially embedded therein; and
at least a second layer having no seed embedded therein.

It is therefore yet another aspect, advantage, objective and embodiment of the invention to provide a consumable container further comprising:
at least a second seed of a different species than the first seed.

It is therefore yet another aspect, advantage, objective and embodiment of the invention to provide a consumable container wherein the body material further comprises:
an at least partially transparent material.

It is therefore yet another aspect, advantage, objective and embodiment of the invention to provide a consumable container further comprising:
a material located at the seed which enhances the growth of the seed.

It is therefore yet another aspect, advantage, objective and embodiment of the invention to provide a consumable container wherein the material which enhances the growth of the seed is located: around the seed, adjacent the seed, in a third space close to the seed, mixed into the body material, embedded in the body material, mixed into the material of a cap of the container, in the first space with the consumable product, and combinations thereof.

It is therefore yet another aspect, advantage, objective and embodiment of the invention to provide a consumable container wherein the material which enhances the growth of the seed is one member selected from the group consisting of: fertilizer, a germination agent, an organism designed to speed breakdown of the body material, an agent designed to speed breakdown of the body material, and combinations thereof.

It is therefore yet another aspect, advantage, objective and embodiment of the invention to provide a consumable container further comprising:
an indentation on the exterior of the container defining a second seed space; wherein the seed is located in the second seed space.

It is therefore yet another aspect, advantage, objective and embodiment of the invention to provide a consumable container wherein the indentation further comprises at least one member selected from the group consisting of:
an outside layer joined to the body over the indentation, a label joined to the body over the indentation, a decoration joined to the body over the indentation, a sub-container joined to the body within the indentation, and combinations thereof.

### BRIEF DESCRIPTION OF THE DRAWINGS

FIG. 1 is a frontal view of a bottle embodiment of the present invention (with no label) showing seeds dispersed within the biodegradable material of the bottle.

FIG. 2 is a perspective view of a box embodiment of the present invention, showing seeds dispersed visibly throughout the biodegradable material of the box.

FIG. 3 is a frontal view of a shopping bag embodiment of the present invention, showing advertising on the bag and seeds of various types dispersed within the fiber material of the bag.

FIG. 4 is a frontal view of a bottle cap embodiment of the present invention showing seeds visibly dispersed throughout the bottle cap but not the bottle.

FIG. 5 is a cross sectional view of an embodiment having the seeds located in a compartment within the material of the container, where they may be invisible to the consumer, or may have additional agents to promote growth.

FIG. 6 is a cross sectional view of an embodiment having multiple layers and having the seeds located in a first layer but not in a second layer.

FIG. 7 is a side view of an embodiment having seeds embedded in the matrix of the body material in an inconspicuous manner, for example by means of using small seeds, or by placing them in deeper layer, using translucent materials or the like.

FIG. 8 is a cross sectional view of an embodiment having seeds contained in a seed space on the exterior of the bottle, in a depression in the bottle.

FIG. 9 is a cross sectional view of an embodiment having seeds embedded in an exterior seed carrier part of the container.

INDEX TO REFERENCE NUMERALS

| | |
|---|---|
| First container embodiment | 100 |
| Body | 102 |
| Top/cap | 104 |
| Top side | 106 |
| Side | 108 |
| Bottom side | 110 |
| Fluffy seed | 112 |
| Visually appealing seed | 114 |
| Seed of appealing plant | 116 |
| Hardy seed | 118 |
| Second container embodiment | 200 |
| Interior of box | 201 |
| Top side/lid | 206 |
| Sides | 208a, 208b, |
| | 208c, 208d |
| Bioengineered seed | 210 |
| Third container embodiment | 300 |
| Body of bag | 302 |
| Partially protruding seed | 324 |
| Handle | 326 |
| Commercial material | 328 |
| Fourth container embodiment | 400 |
| Bottle body | 402 |
| Bottle cap | 404 |
| Durable seed | 430 |
| Label | 432 |
| Indicia to use biodegradable waste bags | 434 |
| Fifth container embodiment | 500 |
| Body | 502 |
| Cap | 504 |
| Bottle bottom | 510 |
| Secondary compartment | 536 |
| Seed/growth agent mix | 538 |
| Sixth container embodiment | 600 |
| Interior/primary space | 601 |
| Body material | 602 |
| Cap | 604 |
| Partially embedded seed | 624 |
| Neck | 640 |
| Threading | 642 |
| Seed-less layer body material | 644 |
| Body material layer with seeds | 646 |
| Seventh container embodiment | 700 |
| Body | 702 |
| Cap | 704 |
| Inconspicuous seed | 748 |
| Eighth container embodiment | 800 |
| Body | 802 |
| Cap | 804 |
| Indentation | 854 |
| Sub-container | 856 |
| Seed/fertilizer mix | 858 |
| Outside layer/third layer | 860 |
| Ninth container embodiment | 900 |
| Body | 902 |
| Outside layer/decoration/label | 960 |
| Seed | 962 |

### DETAILED DESCRIPTION

Sales of consumable goods account for a large amount of the wastes generated each year in most nations. A short list of the types of such goods, each coming in its own special container, begins to show the dimensions of the problem: consumable goods include foods such as beverages sold in paper and plastic containers, hair care products, skin care products, cosmetics, small articles such as those sold in cardboard boxes or in plastic bubbles on cardboard backing, shopping bags of paper and cloth, boxes of every type from delivery boxes to gift boxes to cardboard crates and so on. In each case, a consumable good (eggs, milk, shampoo and so on) is sold, used, and the container goes by circuitous channels to a landfill, there to rot away at a slow pace, impeding plant growth and offering a cumulatively nauseating spectacle. These small containers and the items associated therewith may be considered to be “consumable goods” for purposes of this patent.

Reference art noted in the “Background to the Invention” provides some limited relief to this problem by providing various types biodegradable materials. Obviously, some materials such as low chemical paper products and raw fiber cardboard biodegrade fairly quickly. Others, such as plastics, may last an unfortunate length of time, which is the reason why most materials announced as “biodegradable” fall into the category of polymers/plastics: most paper and pulp products biodegrade relatively quickly in any case.

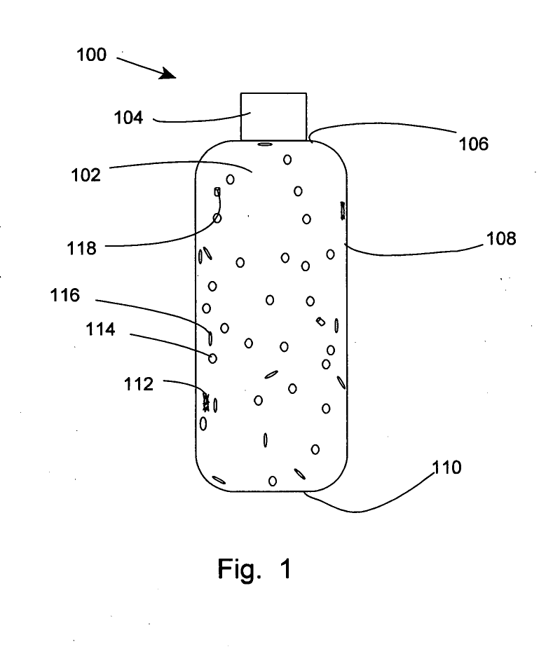

FIG. 1 is a frontal view of a bottle embodiment of the present invention (with no label) showing seeds dispersed within the biodegradable material of the bottle. First container embodiment 100 is in the shape of a bottle without a label. Body 102 is made of a biodegradable material, while top/cap 104 may be made of a biodegradable material as well. In embodiments, one portion or part may be biodegradable material while another portion or part is not. Body 102 has top side 106, side 108, bottom side 110. All of these sides, or a selection thereof, may be made of biodegradable materials and may have embedded or partially embedded in them seeds. Fluffy seed 112 may be selected based upon visual appeal or because once a single example of the species successfully germinates and grows at a landfill, the wind-borne seeds will be prone to quickly cover the landfill: dandelion species for example. Visually appealing seed 114 may be selected for a pretty color or shape. Seed of appealing plant 116 may be selected based upon the general nature of the plant as appealing (“Wildflowers”), or it may be selected for an appealing name (“Rosemary and Thyme”) or for a positive connotation (“Aloe Vera plants”) or for another appealing reason. Finally, hardy seed 118 may be selected based upon an ability to withstand production of the container 100, ability to germinate in a biodegradable matrix, ability to grow in landfill conditions, ability to reproduce, suitability to the climate for which the product is distributed or used and so on. Thus hardy seed 118, if used in a product distributed to a more northern area, might be a seed well adapted to cool climates, while if used in a desert, might be well adapted to low water growth, and so on.

The word “seed” as used herein includes not only traditional seeds but as practical also spores, achenes, chitted seeds, cuttings and the like.

The container 100 may be adapted to a wide range of products, including shampoos, conditioners, beverages, cosmetics, toys, electronics, food, newspapers, groceries and similar consumable items.

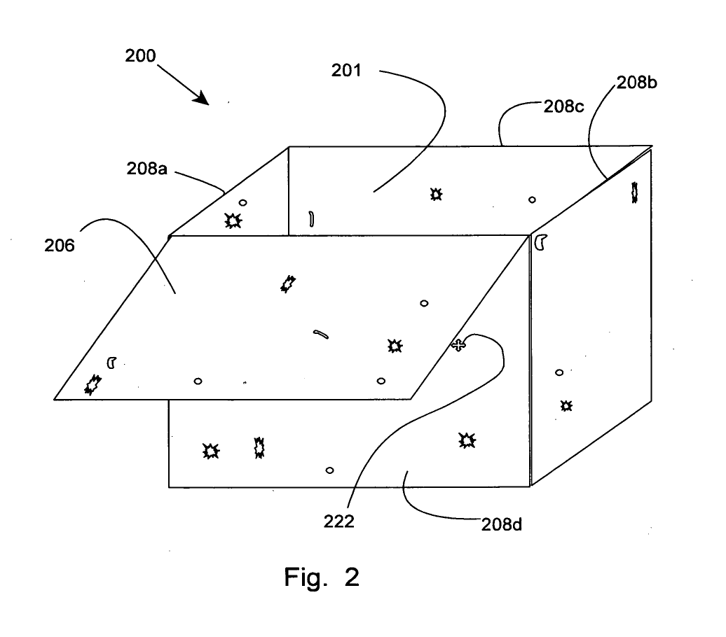

FIG. 2 is a frontal view of a box embodiment of the present invention, showing advertising on the bag and seeds of various types dispersed within the fiber material of the box. The typical materials of such boxes include plastic, paper, cardboard and combinations thereof, but any biodegradable box material now known or later developed may be used. Second container embodiment 200 has interior 201 dimensioned and configured to accept a consumable good. For example, the interior of an egg box has numerous small valleys and peaks designed to accept individual eggs, while a box for an automotive part will be sized to keep the heavy metal object secured against the sides of the box, and so on.

Top side/lid 206 and sides 208a, 208b, 208c, 208d (including front and back sides as well as “sides”) may each, with the bottom, have seeds embedded therein, or only certain ones of the sides may have the seeds therein. Note that bioengineered seed 210 may be used. Bioengineering of seeds in the present invention may in the long term prove profitable, as the seeds could be designed for increased germination and better growth in conditions of the biodegradable matrix and the landfill.

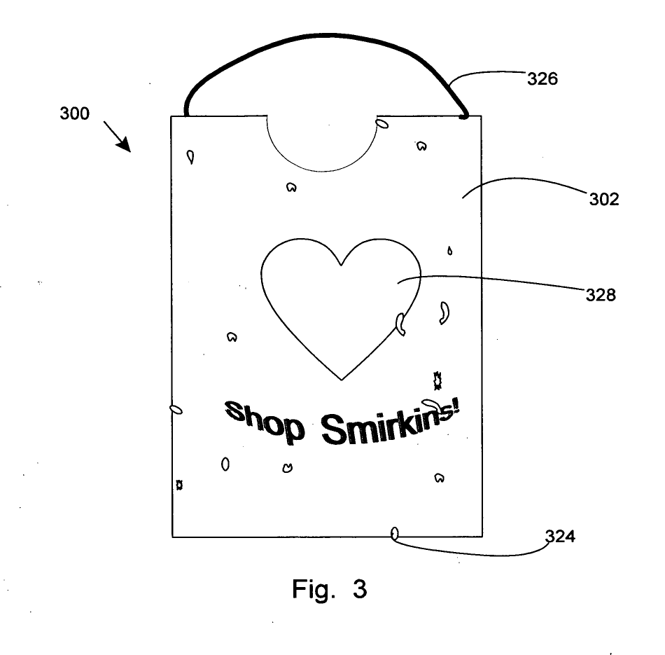

FIG. 3 is a perspective view of a bag embodiment of the present invention, showing seeds dispersed visibly throughout the biodegradable material of the bag, which may be a plastic, cloth, paper, cardboard, or the like.

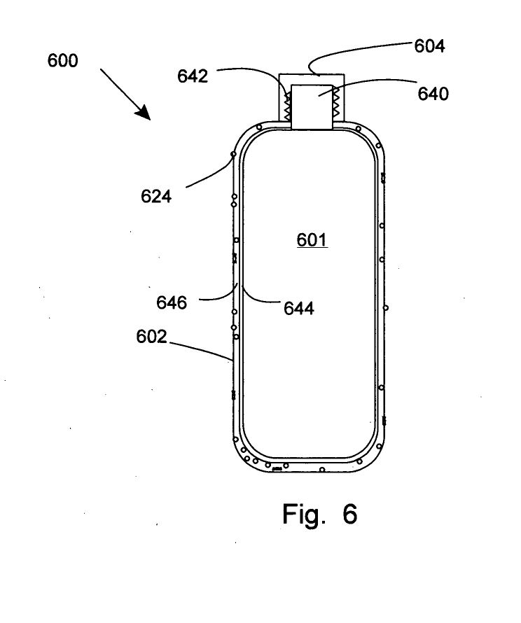

Plastics/polymers which are suitable for biodegradable use in the present invention include polymers based upon artificially created mers and those based upon naturally occurring products such as corn. Bi-polymers, polymers having inclusions and modifiers and other types of polymers may all be used, provided only that the polymers selected for the task retain their suitability for the original task of serving as consumer packaging. Thus, polymers for foods should be non-toxic and non-reactive, those for cosmetic products should not react with the various chemical ingredients of the cosmetic, and so on. Biodegradable paper/pulp products should readily accept ink for printing and should retain the ink, without allowing it to exit the container and stain or discolor products in the container. Such considerations are well known in the industry. Further discussion of this may be found in reference to multi-layer containers such as that discussed in reference to FIG. 6.

Third container embodiment 300 is a shopping bag embodiment, such as is used by large department stores to advertise themselves as shoppers move about after shopping.

Body of bag 302 have be made of a material having partially protruding seed 324 (also “partially embedded seed 324”) which is not entirely surrounded by the matrix of the material of the container. This partial protrusion/embedment may promote germination of the seeds.

Handle 326 allows easier use of the bag and may be biodegradable in embodiments, or may further contain seeds in other embodiments.

Commercial indicia 328 may be as is known in the art to serve as advertisement or for other purposes. Note that seeds may be present in both portions of the bag having commercial indicia and in portions not having commercial indicia, and in embodiments non-commercial indicia may be used.

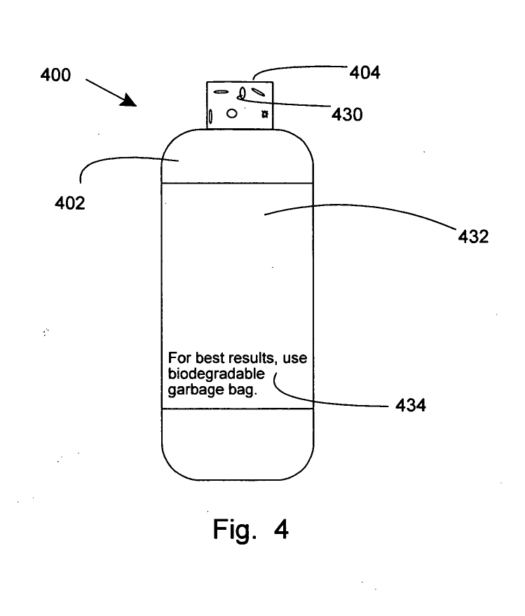

FIG. 4 is a frontal view of a bottle cap embodiment of the present invention showing seeds visibly dispersed throughout the bottle cap but not the bottle. Fourth container embodiment 400 allows a more controlled environment for the user: seeds are only present in one portion of the container and not in another, thus easing concerns due to a new product, or allowing greater control of product/package/container appeal.

Bottle body 402 thus may be biodegradable or not, while bottle cap 404 is definitely degradable. In use, a degradable portion of a container may either degrade and act as a rooting medium for the sprouts, so that sprouts and roots actually begin life growing through the biodegrading material, or they material may degrade to such an extent that it entirely releases the seed from the matrix of the material.

Durable seed 430 may particularly be selected for the ability to withstand paper making processes (for paper or cardboard products and containers) or to withstand plastic molding or extrusion processes (for polymer/plastic containers and products). Seeds may thus be selected for the thickness of the seeds protective integuments, toughness of the seed structure or the like.

Label 432 may customarily be used on any of the embodiments of the invention, label 432 is shown merely to demonstrate this fact. However, it is worth further noting that label 432 or some other part of the invention may bear thereon indicia to use biodegradable waste bags 434. These indicia will indicate that the consumable product container has a biodegradable material and seeds, and that the chance of successful germination and greening of landfills will increase if the product is disposed of using a biodegradable waste container (a biodegradable garbage bag, for example).

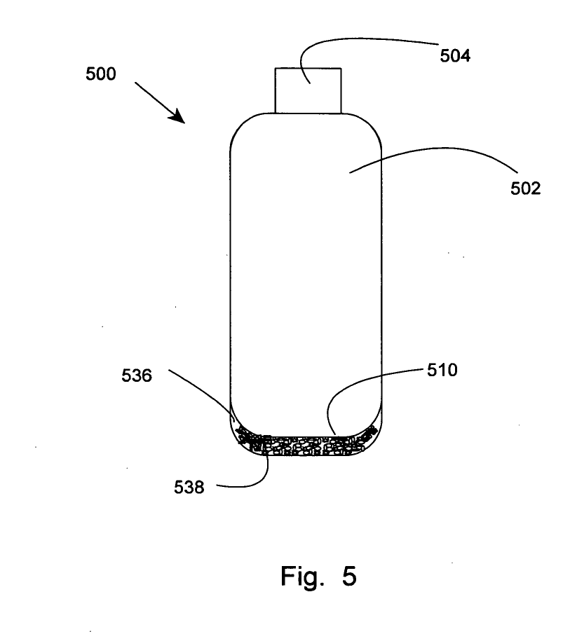

FIG. 5 is a cross sectional view of an embodiment having the seeds located in a compartment within the material of the container. Fifth container embodiment 500 may have body 502 and cap 504, and bottle bottom side 510. A secondary compartment 536 (the primary compartment is that compartment adapted to contain the consumer product contained in the container) may have therein the seeds of the invention, thus being a “seed compartment” or “sub-container” of the container. This may offer enhanced visual appeal, or may reassure consumers uncertain about having seeds mixed throughout the entire container, and finally may allow provision of a much more beneficial start to growth of the seeds.

Another beneficial structure for the seed may be the addition of agents designed to increase the ability of the seeds to germinate or grow. Seed/growth agent mix 538 may contain fertilizer or a similar product. In the alternative, it may contain hormones of natural or artificial type which increase the ability of the seeds to grow, or as discussed in reference art, it may contain microorganisms which aid the breakdown of the biodegradable container.

Manufacture of such sub-containers may be accomplished such that the sub-container is a unitary body with the main body and is constructed as part thereof, or the sub-container may be manufactured separately then affixed (joined) to the main container. As an example, the bottom compartment 536 may be a space created at manufacture of the main body 502, or it may be manufactured separately and then affixed thereto by a heat process which welds or joins the two together to make one body. It is felt that a single body of biodegradable material as is described is much preferable to a pair of separable bodies, as a pair of separable bodies/containers would sometimes come loose from each other, may require special handling by the user/consumer, would lack esthetic appeal and so on.

FIG. 6 is a cross sectional view of an embodiment having multiple layers and having the seeds located in a first layer but not in a second layer. In the presently preferred embodiment and best mode presently contemplated for carrying out the invention, one layer may be selected from considerations involving successful primary use of the container. For example, an inner layer may be used to insulate seeds from the products within the container, so as not to require lengthy reviews of the interactions of the seeds and the products. Sixth container embodiment 600 may have interior/primary space 601 dimensioned and configured to hold consumer product, while body material 602 may not only be biodegradable but in layers thereof may actually have agents designed to promote growth of the seeds, as discussed in relation to FIG. 5. Cap 604 may be of similar or differing construction, and has neck 640 protruding from the body 602 there into. Threading 642 on the neck 640 and cap 604 may allow sturdy engagement. A “necked” bottle like this may be suitable for shampoo, conditioner, orange juice or the like.

Seed-less layer body material 644 may insulate the product from the seeds found in body material layer with seeds 646. The materials of the multiple layers may be distinct first and second materials, and in embodiments, one layer may even be non-biodegradable. The number of layers and their arrangement may be subject to change: in embodiments, the device may have more than a single layer having seeds and more than a single layer not having seeds.

Partially embedded seed 624 may have increased chances of germination and growth, and may increase the consumer appeal of the device of the invention by providing to buyers a solid tactile feel of the “good work” they are doing.

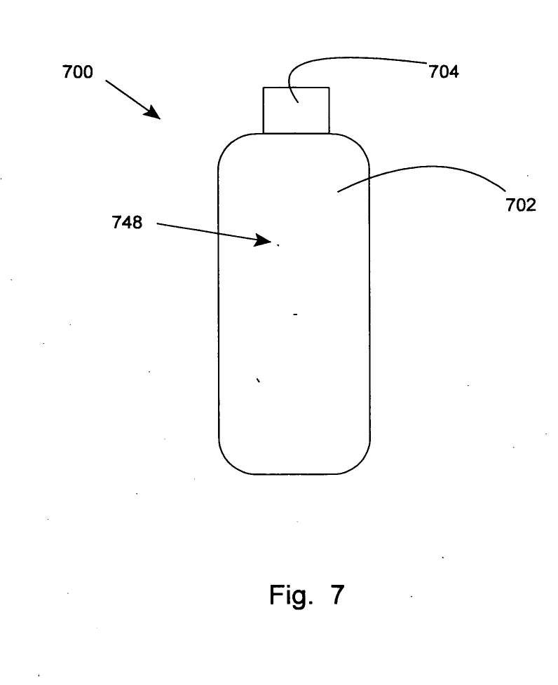

FIG. 7 is a side view of an embodiment having seeds embedded in the matrix of the body material in an inconspicuous manner, for example by means of using small seeds, or by placing them in deeper layer, using translucent materials or the like.

Seventh container embodiment 700 has body 702 which may be transparent, partially transparent, translucent or entirely light blocking. Cap 704 may have similar or differing properties. Inconspicuous seed 748 may also be used to again provide consumer reassurance or increased aesthetic appeal.

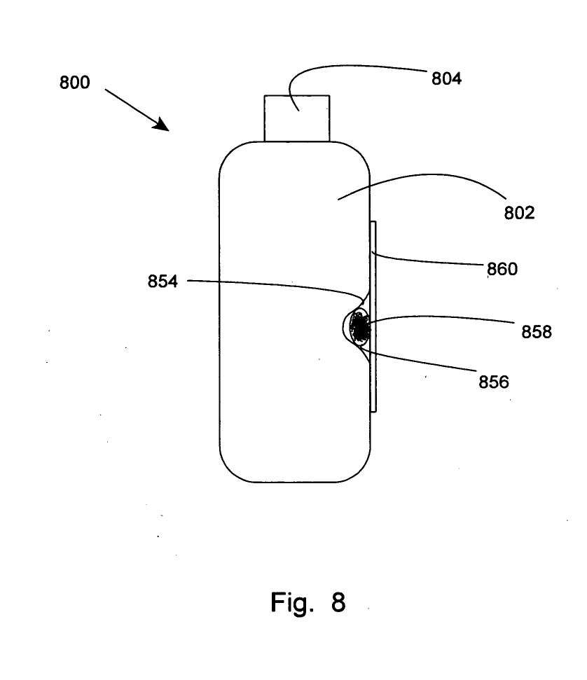

FIG. 8 is a cross sectional view of an embodiment having seeds contained in a seed space on the surface of the bottle, in a depression in the bottle. Eighth container embodiment 800 has body 802 and cap 804. It also has, on an exterior surface, indentation 854 in which seeds are located. Optional sub-container 856 may be joined to the body 802 and may have therein a secondary seed space containing seed/fertilizer mix 858. Optional sub-container 856 may be joined to the body or cap at an exterior location as shown or at an interior location (see FIG. 5). Indentation 854 may be interior or exterior to the main body of the bottle.

Over the indentation 854 an outside layer/third layer 860 may be joined to the container so as to completely or partially cover the indentation. This third layer 860 may advantageously be a biodegradable material or may in embodiments be a non-biodegradable material.

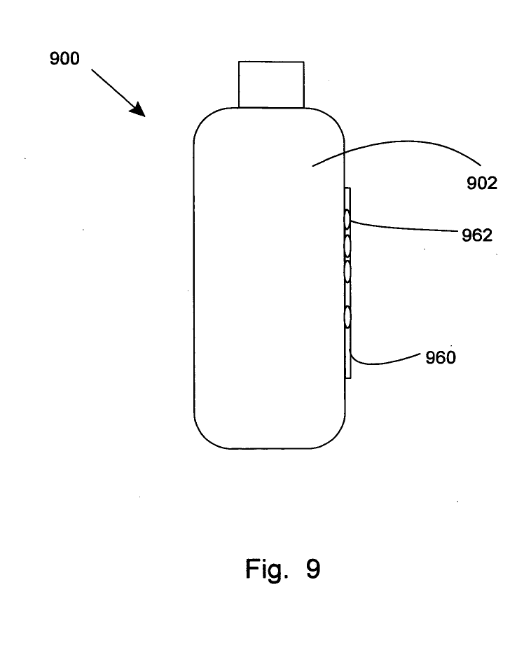

FIG. 9 is a cross sectional view of an embodiment having seeds embedded in an exterior seed carrier part of the container. Ninth container embodiment 900 has body 902 having a third layer/outside layer/decoration/label 960 joined to body 900 (or in embodiments to a cap) containing seed 962 embedded therein. The third layer may of course be joined to an interior portion of the container, for example, to an interior surface of the primary consumable product space within the body.

It will immediately be understood that outside layer 960 may do double duty as a label, a logo, a decoration, and so on, and may of course bear indicia of commercial origin, instruction for use or any other indicia as required or desired.

It will be understood that a low rate of germination and growth may be acceptable and unavoidable. For example, only those containers which are disposed of on a semi-permanent or permanent “top layer” will be likely to nurture successful floral growth. Similarly, those containers disposed of in adverse conditions (burned, recycled, located in toxic locations and so on) may not produce a bountiful growth. However, this low percentage of success is acceptable since the sheer volume of disposable consumer waste is so great that large numbers of the consumable products and containers of the invention will be disposed of and thus the low percentage of individual success will translate into near certainty of sprouting of plants, followed by quick spreading of those species adapted to the environment in which they find themselves. A variety of seeds in each container may thus be beneficial so as to maximize the chances of one or more types being successful in greening the landfill.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A consumable container comprising:
a body made of a material;
a first space within the body dimensioned and configured so as to accommodate a consumable product; and
at least one seed at least partially within the container, and at a location within the container other than the first space.

2. The consumable container of claim 1, further comprising:
a second space, and further wherein:
the seed is located in the second space.

3. The consumable container of claim 1, wherein the body material further comprises:
a biodegradable material, and further wherein:
the seed is at least partially embedded in the biodegradable material.

4. The consumable container of claim 1, further comprising:
a cover of a biodegradable material; and further wherein:
the seed is at least partially embedded in the biodegradable material of the cover.

5. The consumable container of claim 1, further comprising:
a sub-container within the container, the sub-container having a seed space therein, wherein:
the seed is located in the seed space.

6. The consumable container of claim 1, further comprising:
a sub-container on the exterior of the container and part thereof wherein:
the seed is located in the sub-container.

7. The consumable container of claim 3, wherein the biodegradable material further comprises one member selected from the group consisting of: natural polymers, artificial polymers, paper, fiber, cardboard, fabric, foams, composites thereof and combinations thereof.

8. The consumable container of claim 1, wherein the body further comprises one member selected from the group consisting of:
a bottle, a bag, a box, a food container, a cosmetic container, and an optical disk container.

9. The consumable container of claim 1, wherein the seed is selected from the group consisting of: seeds of wildflowers, seeds of grasses, cuttings, spores, achenes, bioengineered seeds, chitted seeds with dormancy broken, seeds of plants selected for high germination rates, seeds of plants selected for name appeal, seeds of plants selected for appealing appearance of the seed, seeds of plants selected for appealing appearance of the plant, seeds selected for ability to germinate within the matrix of the biodegradable material, seeds selected based upon climates in which the consumable container may be expected to be emptied and disposed of, seeds selected for ability to withstand manufacture of the container, and combinations thereof.

10. The consumable container of claim 1, further comprising:
indicia urging disposal of the consumable container in a biodegradable garbage container.

11. The consumable container of claim 1, wherein the seed is entirely embedded within the material of the body of the container.

12. The consumable container of claim 1, wherein the seed is at least partially exposed from the material of the body of the container.

13. The consumable container of claim 1, wherein the body of the container further comprises:
at least a first layer having the seed at least partially embedded therein; and
at least a second layer having no seed embedded therein.

14. The consumable container of claim 1, further comprising:
at least a second seed of a different species than the first seed.

15. The consumable container of claim 1, wherein the body material further comprises:
an at least partially transparent material.

16. The consumable container of claim 1, further comprising:
a material located at the seed which enhances the growth of the seed.

17. The consumable container of claim 16, wherein the material which enhances the growth of the seed is located: around the seed, adjacent the seed, in a third space close to the seed, mixed into the body material, embedded in the body material, mixed into the material of a cap of the container, in the first space with the consumable product, and combinations thereof.

18. The consumable container of claim 16, wherein the material which enhances the growth of the seed is one member selected from the group consisting of: fertilizer, a germination agent, an organism designed to speed breakdown of the body material, an agent designed to speed breakdown of the body material, and combinations thereof.

19. The consumable container of claim 1, further comprising:
an indentation on the exterior of the container defining a second seed space; wherein the seed is located in the second seed space.

20. The consumable container of claim 19, wherein the indentation further comprises at least one member selected from the group consisting of:
an outside layer joined to the body over the indentation, a label joined to the body over the indentation, a decoration joined to the body over the indentation, a sub-container joined to the body within the indentation, and combinations thereof.
